(19) United States
(12) Patent Application Publication
(10) Pub. No.: US 2026/0333532 A1
(43) Pub. Date: Oct. 22, 2026

(54) ILLUMINATION DEVICE

(71) Applicant: GLP GERMAN LIGHT PRODUCTS GMBH, Karlsbad (DE)

(72) Inventor: Udo KUENZLER, Karlsbad (DE)

(21) Appl. No.: 19/691,668

(22) Filed: May 29, 2026

Related U.S. Application Data
(63) Continuation of application No. PCT/EP2024/083733, filed on Nov. 27, 2024.

(30) Foreign Application Priority Data
Dec. 1, 2023 (EP) 23213743.0

(51) Int. Cl. H05B 45/10; H05B 45/20

(52) U.S. Cl. CPC H05B 45/10; H05B 45/20

(57) ABSTRACT

An illumination device includes two illumination sections. The first illumination section includes a plurality of illumination elements that are each configured to emit light in a light spectrum, wherein the light spectrum is variable. The second illumination section includes one or several illumination elements that are each configured to emit light in a fixed light spectrum, wherein the fixed light spectrum is white.

### CROSS-REFERENCE TO RELATED APPLICATIONS

This application is a continuation of copending International Application No. PCT/EP 2024/083733, filed Nov. 27, 2024, which is incorporated herein by reference in its entirety, and additionally claims priority from European Application No. EP 23213743.0, filed Dec. 1, 2023, which is also incorporated herein by reference in its entirety.

Embodiments of the present invention relate to an illumination device and to a panel having at least two illumination sections wherein at least one section comprises a plurality of illumination elements being independently controllable. Some embodiments relate to a stroboscope.

### BACKGROUND OF THE INVENTION

A stroboscope is a flash unit emitting light flashes at regular time intervals, whereby, in a dark environment, movements appear chopped as a sequence of still images. The time intervals and the frequency, respectively, can typically be varied in the range between 0.5 and 100 Hz or normally between 1 and 50 Hz. The flash period is for example below 30 ms, below 20 ms or below 10 ms or even below 5 ms.

According to conventional technology, xenon flash lamps or light emitting diodes (LED) and LED arrays, respectively, are frequently used as light source. Due to the need for high light energy with simultaneously short light pulse, these light sources are particularly well-suited. The need for high light energy is frequently met by the fact that the stroboscope light sources emit white light that consists, in a physical sense, of portions of all wavelengths of the visible spectral range. An equi-energy mixture is desired, which is virtually impossible to realize, so that, in a broader sense, white light also means daylight, such as sunlight or norm light having a specific color temperature.

In illumination technology, stroboscopes are frequently used in combination with other illumination fixtures for colored stage lighting. In such illumination devices, either standard illumination means with color screens or colored LEDs, such as RGB LEDs are used. RGB LEDs can be varied in color depending on their control. In that way, RGB LEDs can also emit white light. However, due to their technical characteristics, RGB LEDs do not have the energy density for realizing stroboscope effects. Thus, there is a need for an improved approach.

### SUMMARY

According to an embodiment, an illumination device in combination with a controller, may have: a first illumination section with a plurality of illumination elements that are each configured to emit light in a light spectrum, wherein the light spectrum is variable; a second illumination section with one or several illumination elements that are each configured to emit light in a fixed light spectrum, wherein the fixed light spectrum is white; wherein the first illumination section is geometrically divided into two partial sections; wherein the second illumination section is arranged between and/or centered between the two partial sections of the first illumination section; wherein the plurality of illumination elements of the first illumination section are arranged as a matrix and each of the plurality of illumination elements of the first illumination section is separately controlled by the controller; wherein the controller is configured for individually controlling each of the plurality of illumination elements to display a pattern or a sequence of patterns.

According to another embodiment, a system may have at least two inventive illumination devices and a controller or external controller which is configured to control the at least two illumination devices.

According to an embodiment, an illumination device may have: a first illumination section with a plurality of illumination elements that are each configured to emit light in a light spectrum, wherein the light spectrum is variable; a second illumination section with one or several illumination elements that are each configured to emit light in a fixed light spectrum, wherein the fixed light spectrum is white. Here, the first illumination section may be geometrically divided into two partial sections such that the second illumination section is arranged between the two partial sections of the first illumination section (e.g., in the center). The plurality of illumination elements of at least the first illumination section may be individually or selectively controllable. For example, this means that each illumination element of the plurality of illumination elements may be individually controlled.

According to embodiments, the individually controlling may comprise an adjustment of the brightness and/or an adjustment of the intensity and/or an adjustment of the color, etc. Therefore, it is advantageously possible to illustrate a pattern, like letters or an image using the first illumination section or the two parts of the first illumination section. For example, the illumination devices may be arranged as a kind of matrix within the first illumination section or within the first and second part of the first illumination section enabling to image a pattern.

According to further embodiments, it is possible to individually control the illumination elements of each illumination element. When the seeing the entire matrix of the first illumination section or the two parts of the first illumination section, it is possible to reproduce an animation. The example for such an illumination is a moving light spot or in general a movie. The frame rate can vary. For example, a frame may be reproduced for one second or a plurality of seconds. According to embodiments, the frame rate may amount to more than one frame per second, like two frames per second or five frames per second or twenty-five frames per second, etc.

Embodiments of the present invention are based on the finding that a first illuminations section comprising a plurality of elements which might be subdivided into two parts can be used to image a pattern or a movie. Thus, the matrix formed by the first illumination section forms a kind of screen for static/moving image.

According to embodiments, the illumination device comprises a controller having a graphic processor which is configured to receive from external data like image data or movie data and controls individually the plurality of illumination elements of the illumination device.

According to embodiments, the controller can be implemented as external controller controlling a plurality of illumination devices, all capable for imaging a pattern or amination. The external controller controlling two or more illumination devices enables that an image/amination can be reproduced over a plurality of devices, wherein each device reproduces a respective portion of the entire image. Thus, another embodiment provides a system comprising at least two illumination devices in combination with a controller controlling the two illumination devices. Here, the controller may be configured to output the different control signals to the illumination devices. According to embodiments, the controller is configured to partition the entire pattern and/or the entire amination so as to obtain a number of pattern portions and/or animation portions. The number depends on the number of illumination devices which are used within the system. The pattern portions may be arranged side by side and/or abutting and/or adjacent to each other. This principle may also be used for an amination which is subdivided into a sequence of patterns to be illustrated subsequent to each other.

According to another embodiment, an illumination panel may have: a first illumination section with a plurality of illumination elements that are each configured to emit light in a light spectrum, wherein the light spectrum is variable; a second illumination section with a plurality of illumination elements that are each configured to emit light with a fixed light spectrum, wherein the fixed light spectrum is white.

Embodiments of the present invention provide an illumination device having a first and a second illumination section. The first illumination section includes a plurality of illumination elements, such as LEDs or RGB LEDs that are configured to emit light in a light spectrum, wherein the light spectrum is variable. The second illumination section includes one or several illumination elements, such as white LEDs or also other illumination elements configured to emit light in a white fixed light spectrum.

According to embodiments, the arrangement can be described such that a single tube element, respectively, and tubular illumination element or illumination array for white light (for example a stroboscope) is used, which is framed by two LED fields of variable color. When it is assumed that LEDs are used both for the first and the second illuminations sections, these illumination elements can be arranged in a common panel.

The core idea of this invention is the finding that when using two different types of illumination elements in a common illumination device or in a common panel, the advantages of both types can be combined, such that the illumination device can be used both as stroboscope and (simultaneously) also as colored illumination device. Such a system offers the advantage of high functionality and also the realization of light effects with high light energy. Further, blurring and fading effects can also be realized.

According to embodiments, the illumination device includes a control that is configured to control the first illumination section with at least 20 Hz, at least 30 Hz and/or at least 50 Hz for emitting regular stroboscope light flashes. Stroboscope light means white high-energy light flashes. According to embodiments, this control frequency can be varied between 0.5 Hz and the maximum control frequency. The same control can also be provided for the first illumination section, such that the same can emit regular light flashes of a defined color or also with white light. The two illumination sections can be controlled synchronously or asynchronously, such that the energy density advantageously increases during synchronous control.

As already mentioned above, in an embodiment for the first illumination section, RGB LEDs are used, e.g. at least 1000 RGB LEDs. For the second illumination section, LEDs can be used as well, such as LEDs in the number of between 100 and 500 LEDs. From a thermal point of view, the usage of LEDs is reasonable, since LEDs are very efficient and the high energy density causes few thermal problems due to the high concentrated light energy.

According to embodiments, both the first illumination section and also the second illumination section can be divided into fields that can be controlled separately. For example, it would be possible that the first section comprises 10 fields or 12 fields, while the second illumination section comprises 2 or more (e.g. 12) fields. Here, for example, different colors and different luminosities are possible, such that moving light can be realized as well.

According to further embodiments, the illumination device includes a longitudinal housing into which, for example, rectangular illumination sections, e.g. of a panel, are integrated. The longitudinal housing is limited in its longitudinal extension by two lateral faces. According to a further embodiment, additionally, a longitudinal stand is provided comprising bearing blocks that are also limited in their longitudinal extension by lateral faces. The bearing blocks include pivot joints via which the longitudinal housing is connected to the stand, such that the longitudinal housing is rotatably supported around a longitudinal axis extending parallel to the stand and the longitudinal housing, respectively. According to further embodiments, this rotation for example by up to 180° or 190° can be motor-driven. Here, means for motor-driven pivoting, such as a motor with a toothed belt and/or a gear are provided in one of the bearing blocks.

A further embodiment relates to an illumination panel with the two above-discussed illumination sections.

### BRIEF DESCRIPTION OF THE DRAWINGS

Embodiments of the present invention will be detailed subsequently referring to the appended drawings, in which:

FIG. 1 is a schematic illustration of an illumination device according to an embodiment;

FIG. 2 is a schematic illustration of a panel according to an embodiment;

FIGS. 3a, 3b are schematic illustrations of a rectangular panel according to further embodiments;

FIGS. 4a-4c are schematic illustrations of a round panel according to further embodiments;

FIG. 5 shows a schematic representation of three illumination devices being arranged to each other, wherein the respective first illumination section of the illumination device is configured for enhanced control according to embodiments;

FIG. 6a shows a schematic representation of an illumination device, configured to selectively control illumination elements of the first illumination section according to embodiments;

FIGS. 6b-6d show schematic representations of an illumination device according to FIG. 6a using different modes to illustrate further embodiments;

FIG. 6e shows a schematic illustration of the illumination device of FIG. 6a using another mode according to another embodiment; and

FIG. 7a-d schematic illustration to discuss the controlling of the illumination device according to embodiments.

### DETAILED DESCRIPTION OF THE INVENTION

Before embodiments of the present invention will be discussed below based on accompanying drawings, it should be noted that the same elements and structures are provided with the same reference numbers, such that the description of the same is inter-applicable and inter-exchangeable.

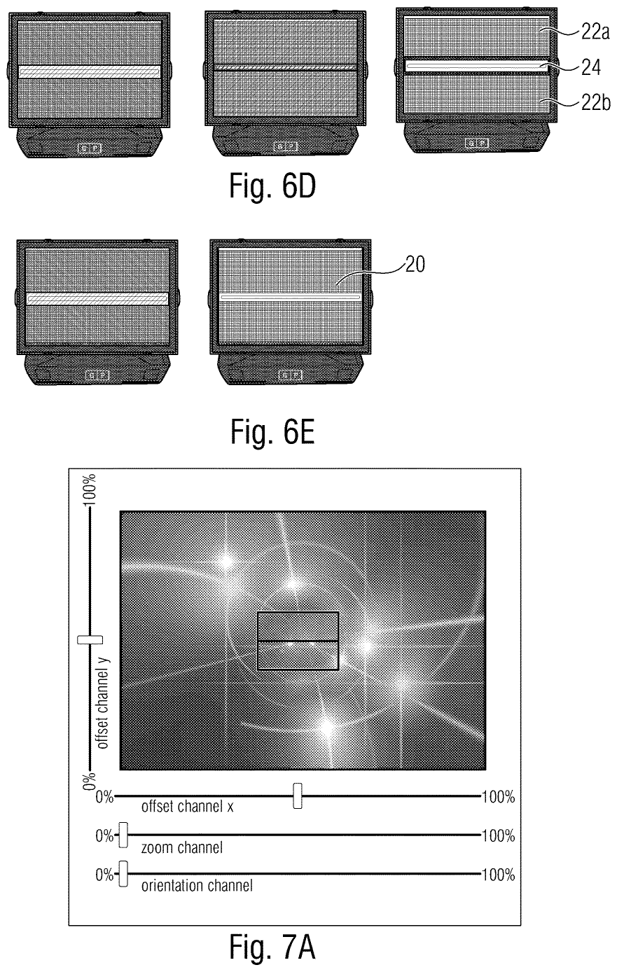

The embodiment of FIG. 6a starts from the principle device 10 including the illumination section 22 and 24, wherein the illumination section 22 is divided into two partial sections 22a and 22b. The partial sections 22a and 22b comprise a plurality of illumination elements, here LEDs, like RGB LEDs. These are marked by the reference numeral 23a, 23b, 23c, 23d, etc. According to this embodiment, all illumination elements 23a, 23b, 23c of the section 22a and/or of the section 22b are individually controllable. For example, it is possible to individually enable and disable single illumination elements 23a, 23b, 23c. Additionally or alternatively, each element 23a, 23b, 23c, etc., can be controlled with regard to brightness, intensity, color and/or duration, etc.

The elements 23a, 23b, 23c are, according to embodiments, individually controlled by a controller (not shown).

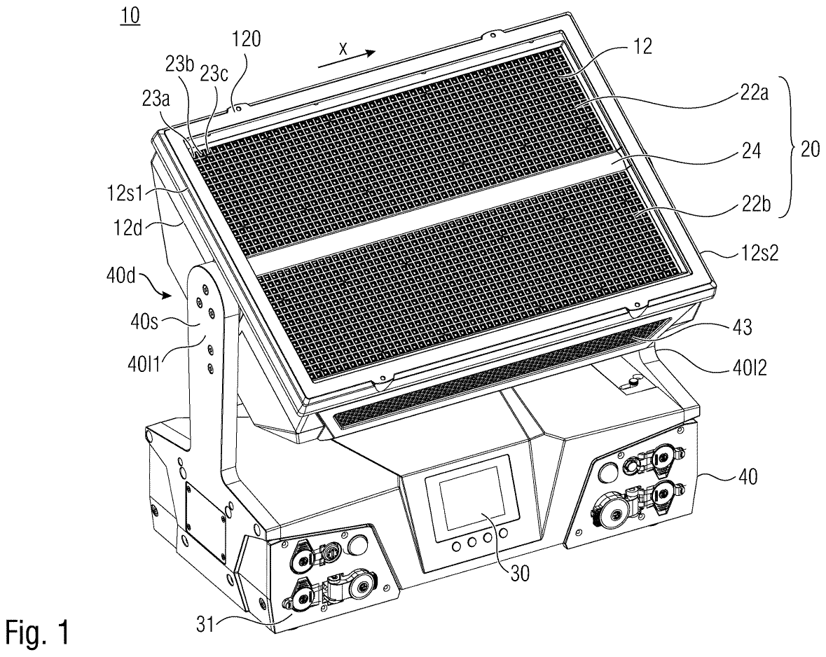

FIG. 1 shows a three-dimensional illustration of an illumination device 10 including a longitudinal housing 12 in this embodiment. The longitudinal housing has a rectangular opening 120 in which a panel 20 is inserted.

The panel 20 includes two illumination sections, namely illumination section 22 and 24. In this embodiment, the illumination section 22 is formed by two partial sections 22a and 22b. All sections 22a, 24 and 22b extend longitudinally along the longitudinal illumination device 10 and along the longitudinal housing 12, respectively. As can in particular be seen in FIG. 1, the panel 20 is rectangular and has, for example, an aspect ratio of 2:1 (length to width).

According to embodiments, the three sections 22a, 22b and 24 are arranged with respect to one another as follows: all three sections 22a, 22b and 24 extend longitudinally along the longitudinal axis. Here, for example, the two partial sections 22a and 22b are of approximately the same size. The section 24 is provided between these two partial sections 22a and 22b. Due to the fact that the two sections are of the same size, a section 24 is centered with respect to the two partial sections 22a and 22b.

The section 22a+22b of the panel includes a plurality of illumination elements 23a, 23b, 23c, . . . , here LEDs or in particular RGB LEDs. Generally, these are illumination elements that are variable with respect to their color spectrum. In this embodiment, the second section 24 is also formed by LEDs, but LEDs with a fixed light spectrum, in particular a white light spectrum. With regard to its geometrical arrangement, this second section emulates a fluorescent tube or flash tube, i.e. the same has a high aspect ratio of, for example, 5:1 (length to width). According to further embodiments, in particular this second section can also be formed by a standard fluorescent tube. Both section 22a+22b and section 24 are formed by a plurality of illumination elements that are repeated both in the longitudinal direction in the respective section as well as in the width direction of the respective section. Section 24 comprises, for example, three or four illumination elements in width and approximately 60 illumination elements in length.

The panel 20 can be provided with an internal or external control (not shown) controlling the three sections 22a, 22b and 24 accordingly or the plurality of illumination elements 23a, 23b, 23c, . . . ,. Here, the control can be implemented such that the RGB LEDs of the sections 22a and 22b can be varied in color. This control can be implemented independently of section 24. This section can also be adjusted with a specific control frequency, such that flashing effects are possible. The control controls the section 24 advantageously like a stroboscope, i.e. with a repeating frequency in the range of 0.5 to 60 Hz or in particular in the range of 1 to 30 Hz. As already explained above, the emitted light flashes have a very short illumination period but also high illumination intensity. This section illumination section 24 can also be controlled independently of the first illumination section 22a+22b. According to a further embodiment, a common control would be possible, such that, for example, both by means of the illumination elements of section 22a and 22b and also by means of the illumination elements of section 24, simultaneous lighting or simultaneous emission of light flashes is possible. The same can also be performed asynchronously, such that color and white stroboscope light flashes are emitted alternately. Thereby, fading effects become possible. By using only LEDs, thermal problems as they typically occur in glass bulb spotlights can be reduced as well. To improve the cooling the housing 12 may comprise air ventilation openings 43.

According to an embodiment, both sections 22a, 22b and section 24 can be divided into sub-sections, such as 12 sub-sections per partial section, such that individual fields can be controlled separately. In other words, the plurality of illumination elements are grouped per illumination section 22a, 22b and 24, such that the same are controlled together. This enables moving light effects that can also move beyond the stroboscope range 24 starting from a continuous panel 20.

Here, it should be noted that, according to embodiments, the section 24 normally comprises approximately 100 to 500 LEDs, such as 216 LEDs, while the complete section 22a+22b normally comprises more than 1000 LEDs, such as 1440 LEDs. The entire panel can receive power, for example, in the order of 1 kW or 1.2 kW and the same can have a lighting efficiency of up to 90% due to the used LED technologies.

Regarding the control it should be noted that the same is controllable via standard protocols, such as DMX-512, ARTNET or RDM. According to embodiments, the illumination device 10 can also include a display with a control. This display is indicated by reference number 30. According to embodiments, the control comprises means for temperature control and in particular for heating control. For remote control of the control, apart from the display a signal connector, such as an XLR-5-Pin connector can be provided (cf. reference number 31).

According to a further embodiment, the longitudinal housing 12 can have a specific shape. As, for example, shown in FIG. 1, the longitudinal extension (cf. x direction) of the housing is limited on the left and right by the two lateral faces 12s1 and 12s2. Additionally, the illumination device includes a stand 40, comprising, in this embodiment, two bearing blocks at the end of the longitudinal extension. These bearing blocks are indicated by reference numbers 40l1 and 40l2. The bearing blocks have pivot joints 40d, via which the longitudinal illumination housing 12 is rotationally supported with respect to the stand 40. Thereby, the housing 12 and hence the panel 20 and the illumination sections 22a, 22b and 24, respectively, can be pivoted around a longitudinal axis. This longitudinal axis extends along the longitudinal extension of the longitudinal stand 40 and the longitudinal housing 12 and parallel to the direction x, respectively.

In order that, according to embodiments, the longitudinal extension of the illumination device 10 is defined not by the stand 40 but in particular by the illumination element 12 with its almost full-surface illumination panel 20, the illumination housing 12 includes, both on the side of the lateral face 12s1 and on the side of the lateral face 12s2, a recess 12a in which the bearing blocks 40l1 and 40l2 are arranged. In the x direction, the recess 12a is of a depth that is deeper than or is the same as the thickness of each bearing block 40l1 and 40l2. This has the effect that the lateral faces 40s of the bearing block terminate in a planar manner with the lateral faces 12s1 or in an essentially planar manner (i.e. up to 5 mm offset, offset ≤5 mm). Further, the dimensioning of the recess 12 a can be designed such that the lateral faces 40s of the bearing blocks are recessed with respect to the lateral faces 12s1 of the housing 12. This has again the same effect, namely that the longitudinal extension (in x direction) is defined by the housing 12 and not by the stand. It is an advantage of such an arrangement that several illumination elements 10 can be arranged beside one another and can be easily positioned since the same are set up with their front faces adjoined to one another. With regard to the set-up it should be noted that the illumination device 10 can practically be used in any set-up. In that way, a set-up by means of the stand 40 can be implemented and, on the other hand, the stand 40 can also be installed on a traverse or similar support devices.

Generally, concerning the dimensioning of the illumination device, it should be noted that the same has, for example, a length of more than 30 or even 40 cm (for example 390 mm), while the width is in the range of 10 to 20 cm (for example 150 mm). The height is in the range of 20 to 30 cm (e.g. 251 mm).

As shown by FIG. 6a the illumination element 23a, 23b and 23c can be individually controlled, i.e., controlled and/or enabled/disabled separately.

As illustrated by FIG. 6d all the elements of the sections, 22a and 22b can be controlled together. According to embodiments, they can be enabled, disabled and controlled with regard to its color together with the illumination section 24. Of course, the illumination section 24 can be controlled separately from the illumination sections 22 and 22a. According to further embodiments, it is possible to enable and to disable all illumination elements of the illumination section 22a, 22b, and 24, so as to illuminate identically (cf. FIG. 6e). Furthermore, it is possible, that the illumination elements of the sections 22a, 22b and 24 are separated into clusters as illustrated by FIG. 6b or 6c.

According to embodiments, different control methods are possible.

For controlling the illation elements of the sections 22a, 22b and 22c different modes can be used. For example, the control procedure can be made by sending control commands for the main module beam, the main module plate and the submodule background/submodule. In the simple case as it is illustrated by FIG. 6e the main module is controlled with respect to tilt, control, intensity, duration, rate, intensity, white, red, green and blue, while the submodule 1 is controlled with respect to intensity, white, red, green and blue. This control mode is also referred to a M1 meaning control mode.

As it is illustrated by FIG. 6d, the main module plate can be further controlled with regard to intensity plate, duration plate, rate plate, intensity FX plate, etc., red, green and blue. This mode is also referred to as M2 basic.

In an M3 normal control mode additional parameters like FX movement beam, mixed prior beam, mixed prior plate, DFX preset, DFX select, DFX speed, DFX orientation, DFX contrast, DFX transition can be input as input commands. Note that the possible commands are not limited to those. The embodiment of FIG. 6c is controlled by the so-called M4 enforcement 12-control mode. Here, for the submodule background the red, green and blue parameters are provided for the 12 individual segments 22s.

In the M5 segment 24-control mode which is illustrated by FIG. 6b 24 segments 22s all comprising red, green and blue parameters are controlled individually.

The M6 multipix advanced control mode enables, for example, to individually control 1728 segments. The same is also possible for the multipix compress control mode M7. Here, the number of individual parameters for the main module beam and the main module plate are reduced. In the embodiment of FIG. 6a, this control mode is the preferred one.

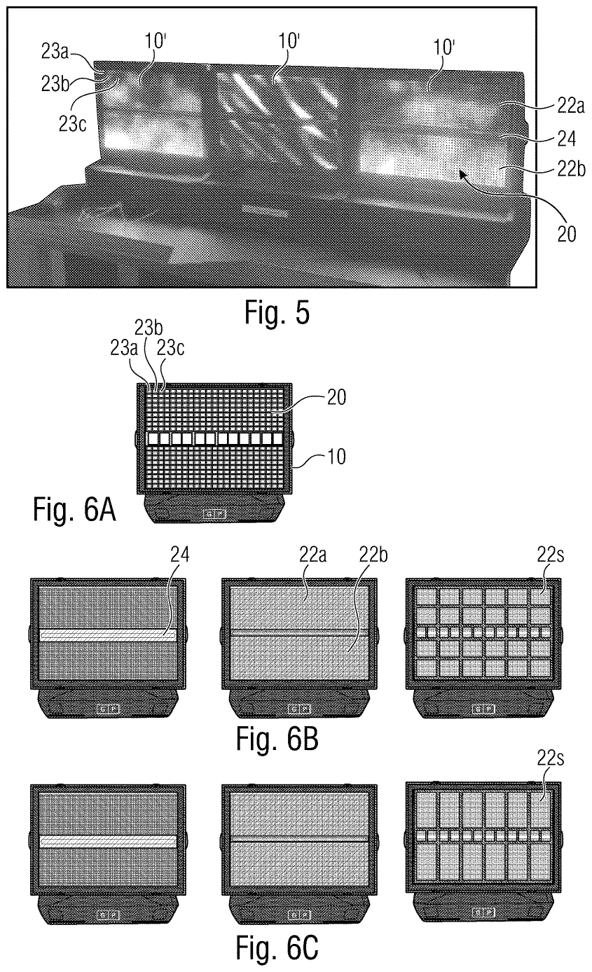

The controlling is performed by a controller (not shown) the controller can be part of the illumination device 10 or can be an external controller. Using an external control has the advantage that a plurality of illumination devices 10′ can be controlled together, as illustrated by FIG. 5.

FIG. 5 shows three illumination device 3′, wherein on each illumination devices 10′, wherein on each illumination device a pattern/image is displayed. According to embodiments, the pattern can be varied from frame to frame, so that an animation is displayed. By use of the plurality of illumination devices 10′ which are centrally controlled, a pattern extending across a plurality of illumination devices can be displayed by use of the illumination devices. In this, each illumination device displays a portion of the entire pattern. According to embodiments, this pattern cross the plurality of illumination devices can be animated.

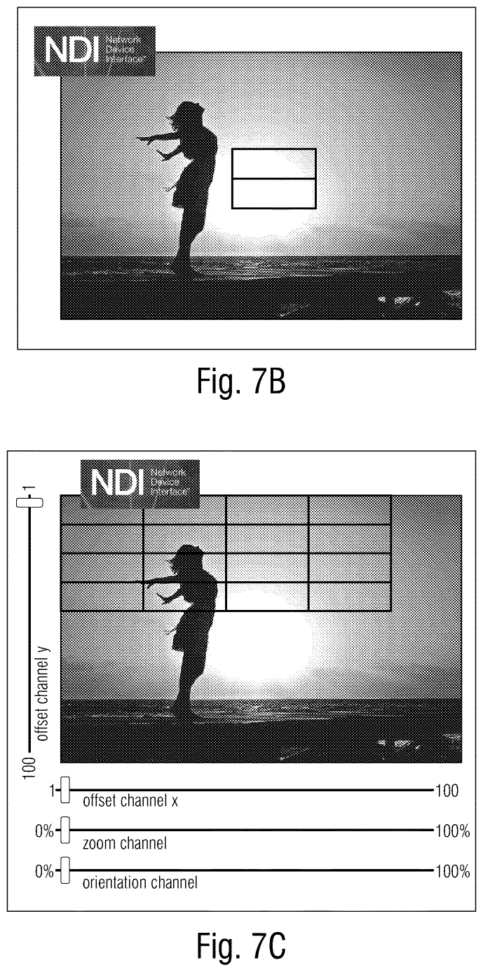

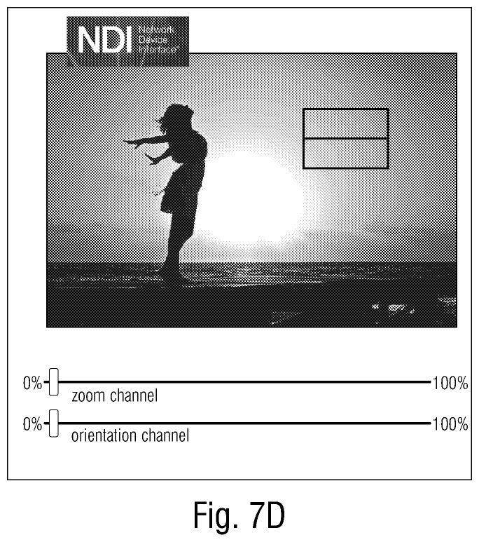

With respect to FIGS. 7a to 7d a software for transferring an image to the one or more illumination devices is discussed. In the first step the image/video is loaded and positioned with respect to the matrix, e.g. 32×54 pixel matrix can be positioned. This procedure is applicable for images and movies. Thus, by use of the software feature, the controller enables program, continuous video like digital effect with unlimited size. There is no fixed frame per minute rate. According to embodiments, the speed can be slowed down without any visible stuttering effects.

The software enables position-, rotation-and zoom DMX channels so that the user can quickly place digital content and move the capture frame over the content for more dynamic effects. The positioning is illustrated by FIGS. 7a and 7b. Note the relative position can be performed as follows. The capture area can be position in the video area by relative (0 to 100 percent) positioning. Additional position-, orientation-and zoom-adjustment can be done by the DMX channel itself. For advanced workflow by using special video software, the capture frame of each illumination device can easily position next by next. This is illustrated by FIG. 7c. For example, the position selection can be set by using the position channels (see FIG. 7d). The DMX adjustment is possible as well.

According to embodiments, different control signals may be used to control the device from externally. For example, DMX, ArtNet or sACN or NDI is possible. Here, by one controller, e.g., one DMX controller, a plurality of illumination devices are controllable.

Although in the above embodiments, the illumination elements of the section 22a and 22b have been discusses as being separately controllable. It should be noted that the white stroke line which might comprise 84 highly efficient 10 W beam LEDs can be controlled in segments as well. For example, 12 individual controllable segments can be used. Note, that the RGB plate LEDs may amount to more than 1000, e.g., up to 1728 LEDs. According to embodiments, black LED shaped mask for a low reflection at a plates area are used. According to embodiments, advanced video capture by up to four external NDI streams with live manipulation would be possible.

In the above embodiments it has been discussed that a graphic processor (GPU=graphics processor unit) may be used. For example, the graphic processor may be integrated on a chip or CPU, like a (powerful) dual-core CORTEX A7 CPU with 3D graphic processing. Such Cortex-A7-Cors can control the entire device and are enabled to process Artnet, sACN, to decode NID signals, etc. Not the GPU may also be in charge of calculating the DigiFX. According to embodiments the controller may use different control mode, e.g., six control modes as discussed above.

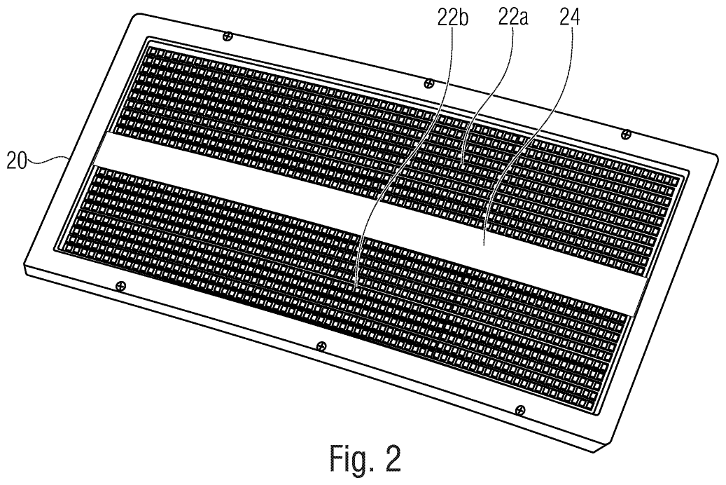

With reference to FIG. 2, a further embodiment, namely the panel 20 will be discussed. The panel 20 includes a first illumination section formed by two partial sections 22a and 22b as well as a second illumination section 24. As discussed with reference to FIGS. 1a-c, this second illumination section is also provided in a centered manner. The panel includes a plurality of illumination elements that are normally arranged in an equidistant manner, wherein the illumination elements in section 24 are the illumination elements of a type where a fixed (predefined) color spectrum, e.g. a white color spectrum, is emitted, while the illumination elements in the section 22a and 22b are variable in each color spectrum. The three sections 22a, 22b and 22s are again implemented in a longitudinal manner. According to further embodiments, the arrangement and the longitudinal arrangement, respectively, of the sections 22a, 22b and 24 can also be implemented differently. Thus, for example, a second section 24 and a third section 22 can be provided, which then alternate accordingly. Instead of the longitudinal orientation of sections 22a, 22b and 24, vertical orientation would also be possible.

According to a further embodiment, the section 24 can be formed by different elements, such as a standard xenon tube arranged between the sections 22a and 22b. Alternatively, it would also be possible that this tube is provided behind the first illumination section (undivided illumination section), such that the tube radiates through the first illumination section.

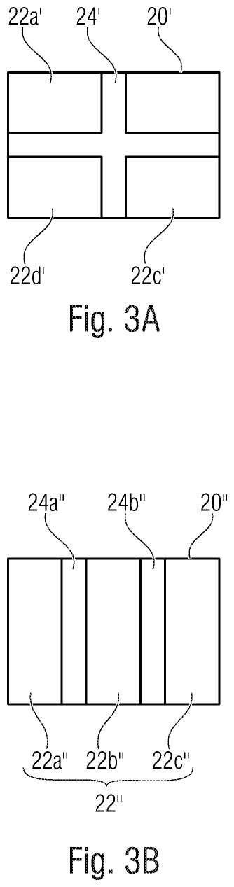

FIG. 3a shows a rectangular panel 20′ with a cross-shaped second illumination section 24′ and, starting from this centrally arranged cross-shaped second illumination section 24′, four first illumination sections 22a′ to 22b′ (each rectangular) arranged in the corners.

FIG. 3b shows a further variation of a rectangular panel 20″ with two second illumination sections 24a″ and 24b″ that are not arranged longitudinally but transversally to the longitudinal direction such that the first section 22″ is divided in three sub-sections.

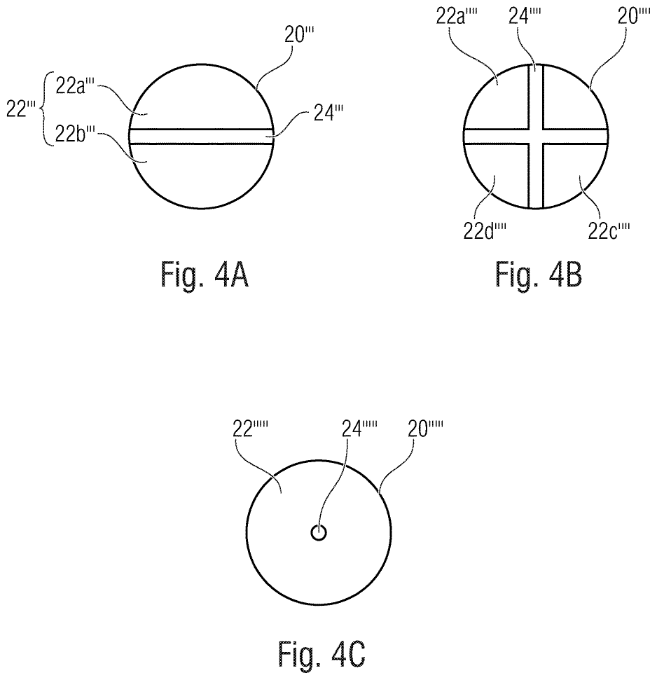

FIG. 4a assumes a rectangular panel 20′″, wherein a line-shaped second section 24′″ (for example aligned in longitudinal direction) divides the first section 22′″ into two crescent-shaped first sections 22a′″ and 22b′″.

FIG. 4b also assumes a round panel 20″″, wherein here again a cross-shaped second section 24″″ is provided which divides the first section in four circular segment-shaped sections 22a″″ to 22b″″.

The panel 20′″″ illustrated in FIG. 4c is also implemented as a round panel and includes a centrally arranged point-shaped second section 24′″″ as well as a first section 22′″″ extending around the central section 24″″.

All panels 20′ to 20′″″ can be installed in the above-discussed illumination unit and in the above-explained housing, respectively. According to embodiments, the panels 20′ and 20″ can be configured in a square manner instead of in a rectangular/longitudinal manner, such that the housing is then adapted accordingly. For panels 20′″ to 20′″″, respectively, a corresponding round housing is provided.

In these doubly symmetrical panels 20′ to 20′″″, according to embodiments, the housing mechanics can also be extended, such that biaxial pivoting is provided.

Generally, it should be noted that both the shape of the panels and the sections can vary according to embodiments (e.g. triangular panel, diagonal sections or the same).

Embodiments provide an illumination device, wherein the first and/or the second illumination section is configured to emit the respective light in the form of stroboscope light flashes, such that the illumination device forms a stroboscope.

According to embodiments, the illumination device may comprise a control that is configured to control the second illumination section with at least 20 Hz, with at least 30 Hz and/or at least 50 Hz to emit regular stroboscope light flashes.

According to embodiments, the control is configured to vary a control frequency between 0.5 Hz and a maximum control frequency.

According to embodiments, the control is configured to control the first illumination section with at least 20 Hz, at least 30 Hz or at least 50 Hz in order to emit regular light flashes and/or stroboscope light flashes.

According to embodiments, the first illumination section comprises at least 1000 illumination elements.

According to embodiments, the second illumination section is formed as stroboscope tube or in the form of a tube.

According to embodiments, the second illumination section comprises more than 100 white LEDs and/or wherein the second illumination section comprises less than 500 white LEDs.

According to embodiments, the several illumination elements of the second illumination section are divided into at least two fields that can be separately controlled.

According to embodiments, the second illumination section is divided into at least three fields.

According to embodiments, the illumination device comprises a longitudinal housing that is limited by two lateral faces in a longitudinal extension.

According to embodiments, the illumination device comprises a longitudinal stand extending parallel to the longitudinal housing; for example, the longitudinal stand comprises two bearing blocks with rotational joints via which the longitudinal housing is supported in a pivotable manner around a longitudinal axis extending parallel to the longitudinal stand and the longitudinal housing with respect to the longitudinal stand.

According to embodiments, the longitudinal housing may comprise two lateral recesses in which the two bearing blocks are arranged, such that the lateral faces of the longitudinal housing and lateral faces which limit the longitudinal extension of the longitudinal stand with its bearing blocks in the longitudinal extension are terminated in a planar manner with respect to one another, or wherein the lateral faces of the longitudinal stand are recessed with respect to the lateral faces of the longitudinal housing.

According to embodiments, a unit for motor-driven pivoting and/or a motor with a toothed belt are provided in at least one of the bearing blocks.

According to embodiments, the longitudinal housing can be pivoted around the longitudinal axis by at least 180°or by 190°.

According to embodiments, the illumination device comprises a housing and a stand, wherein the housing can be pivoted in a biaxial manner or can be pivoted in a biaxial motor-driven manner with respect to the stand.

Embodiments provide an illumination panel, comprising: a first illumination section with a plurality of illumination elements that are each configured to emit light in a light spectrum, wherein the light spectrum is variable; a second illumination section with a plurality of illumination elements that are each configured to emit light with a fixed light spectrum, wherein the fixed light spectrum is white.

According to embodiments, the first illumination section is divided into two partial sections, and wherein the second illumination section is arranged between the two partial sections of the first illumination section or wherein the second illumination section is arranged in a centered manner between the two partial sections of the first illumination section; and wherein the two partial sections and the second illumination section extend in parallel along a longitudinal axis of the panel.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. Illumination device in combination with a controller, the illumination device comprising:
a first illumination section with a plurality of illumination elements that are each configured to emit light in a light spectrum, wherein the light spectrum is variable;
a second illumination section with one or several illumination elements that are each configured to emit light in a fixed light spectrum, wherein the fixed light spectrum is white;
wherein the first illumination section is geometrically divided into two partial sections;
wherein the second illumination section is arranged between and/or centered between the two partial sections of the first illumination section;
wherein the plurality of illumination elements of the first illumination section are arranged as a matrix and each of the plurality of illumination elements of the first illumination section is separately controlled by the controller;
wherein the controller is configured for individually controlling each of the plurality of illumination elements to display a pattern or a sequence of patterns.

2. Illumination device according to claim 1, wherein the illumination elements of the first illumination section and/or the second illumination section are separately controlled with regard to color, intensity and/or illumination duration.

3. Illumination device according to claim 1, wherein the illumination elements of the first illumination section and/or the second illumination section are arranged as a matrix or controllable matrix.

4. Illumination device according to claim 1, wherein a plurality of illumination elements of the first illumination section and/or the second illumination section forming a partial section, wherein the plurality of illumination elements of each partial section are separately controlled so as to display a respective pattern;

5. Illumination device according to claim 1, wherein a plurality of illumination elements of the first illumination section and/or the second illumination section forming a partial section, wherein the plurality of illumination elements of each partial section of each partial section of the first illumination section and/or the second illumination section are separately controlled so as to display an animation or sequence of patterns or different patterns.

6. Illumination device according to claim 1, wherein the controller comprises a graphic processor configured to transform an input signal into the pattern or the sequence of patterns or frame sequence of the patterns to separately control the plurality of illumination elements of the first illumination section or each partial section according to the pattern or the sequence or frame sequence.

7. Illumination device according to claim 6, wherein a frame rate is less than three seconds per frame, less than one second per frame, or at least 2 frames per second, at least 10 frames per second, at least 25 frames per second, at least 50 frames per second or at least 60 frames per second.

8. Illumination device according to claim 1, wherein the second illumination section comprises the plurality of illumination elements of the second illumination section which are separately controlled.

9. Illumination device according to claim 8, wherein the controller is configured to control the plurality of illumination elements of the second illumination section so as to output a pattern and/or an amination over the first and second illumination section.

10. Illumination device according to claim 1, wherein the first illumination section and the second illuminations section are arranged in a common plane.

11. Illumination device according to claim 1, wherein the first illumination section and the second illumination section are arranged or implemented as separate modules attached to each other in a common plane or wherein the first illumination section and the second illumination section are arranged implemented as separate modules and wherein the first illumination section is attached to the second illumination section or wherein the second illumination section is attached to the first illumination section.

12. Illumination device according to claim 1, wherein the control is configured to control the first illumination section and the second illumination section in a synchronous or asynchronous manner.

13. Illumination device according to claim 1, wherein the illumination elements of the first illumination section comprise RGB LEDs.

14. Illumination device according to claim 1, wherein the second illumination section comprises several white LEDs as illumination elements.

15. Illumination device according to claim 1, wherein a illumination panel comprising the first illumination section and/or the second illumination section is rectangular or round.

16. Illumination device according to claim 1, wherein the controller is an internal controller which is configured to control the illumination device and another illumination device.

17. Illumination device according to claim 16 wherein the controller is configured to partition the pattern into a plurality of sub-patterns or to partition patterns of a sequence into a plurality of sub-patterns.

18. System comprising at least two illumination devices according to claim 1 and a controller or external controller which is configured to control the at least two illumination devices.

19. Illumination device according to claim 1, wherein each illumination element of the first illumination section is individually controllable.

20. Illumination device according to claim 1, wherein the controller is configured for multipix advanced control mode.
